(19) United States
(12) Patent Application Publication
(10) Pub. No.: US 2021/0013553 A1
(43) Pub. Date: Jan. 14, 2021

(54) RECHARGEABLE BATTERY

(71) Applicant: Mahle International GmbH, Stuttgart (DE)

(72) Inventors: Ingo Haeusler, Esslingen (DE); Dierk Hoffmann, Leonberg (DE); Ruediger Knauss, Kernen i.R. (DE)

(21) Appl. No.: 16/924,164

(22) Filed: Jul. 8, 2020

(30) Foreign Application Priority Data
Jul. 9, 2019 (DE) 10 2019 210 057.0

(51) Int. Cl. H01M 10/42; H01M 2/10; B60K 1/04; B60K 11/02; B60L 50/60; B60L 58/26; H01M 10/613; H01M 2/36

(52) U.S. Cl. CPC H01M 10/42; H01M 2/1077; B60K 1/04; B60K 11/02; H01M 2220/20; B60L 58/26; H01M 10/613; H01M 2/36; B60L 50/66

(57) ABSTRACT

A rechargeable battery may include a housing and a plurality of rechargeable battery cells accommodated in an internal volume of the housing. The housing may include a first housing part and a second housing part. A tension rod may undoably couple the first housing part and the second housing part. The tension rod may include a bolt and a bolt head. The bolt may be guided through the internal volume and may include a structure configured to form an undoable connection with a counter-structure arranged on the first housing part. The second housing part may include a feed-through orifice open to the internal volume and a surrounding environment of the housing. A plug may, when in an open position, open up a fluidic drain path from the internal volume to the surrounding environment of the housing. The plug may also, when in a closed position, shut off the drain path.

### CROSS-REFERENCE TO RELATED APPLICATIONS

This application claims priority to German Patent Application No. DE 10 2019 210 057.0, filed on Jul. 9, 2019, the contents of which is hereby incorporated by reference in its entirety.

### TECHNICAL FIELD

The present invention relates to a rechargeable battery with housing parts, between which is accommodated at least one rechargeable battery cell, an internal volume formed by the housing parts being at least partially full, during operation, of a liquid fluid.

### BACKGROUND

Rechargeable batteries are electrical power sources generally comprising a plurality of rechargeable battery cells. Such rechargeable batteries are suitable for use in numerous applications and are also increasingly being used in motor vehicles.

Increasing demands placed on the storage capacity and/or performance of rechargeable batteries are resulting in the rechargeable battery cells requiring temperature control, in particular cooling. The rechargeable battery cells are here accommodated in a housing of the rechargeable battery, wherein a temperature control means is usually mounted externally on the housing in a heat-transferring manner in order to control the temperature of the rechargeable battery cells.

Cooling efficiency may be boosted by the housing, during operation, being full of a liquid fluid which surrounds the rechargeable battery cells and thus controls their temperature, in particular cools them.

Such a rechargeable battery is known for example from DE 10 2018 215 036 A1. The rechargeable battery housing here comprises two housing parts which bound an internal volume of the housing in which rechargeable battery cells of the rechargeable battery are accommodated.

Due to the liquid fluids present in the housing during operation, such rechargeable batteries are subjected to increased mechanical loads, in particular internal pressures. The maintenance of such rechargeable batteries, for example for replacement of the rechargeable battery cells, is furthermore made more difficult.

### SUMMARY

The present invention therefore addresses the object of providing an improved or at least different embodiment for a rechargeable battery of the initially stated type which is distinguished by increased mechanical stability and simplified maintenance of the rechargeable battery.

This object is achieved according to the invention by the subject matter of the independent claim(s). Advantageous embodiments constitute the subject matter of the dependent claim(s).

The present invention is based on the general concept of mechanically stabilising a two-part housing of a rechargeable battery, which is at least partially full, during operation, of a liquid fluid for temperature control of rechargeable battery cells which are accommodated in the housing, with a tension rod and providing a plug which, when required, permits draining of the fluid from the housing. The tension rod fastens the housing parts to one another, so counteracting internal pressure generated in the housing with the fluid. As a consequence, any deformation of the housing brought about by said internal pressure is prevented or at least reduced, such that the housing and consequently the rechargeable battery are mechanically stabilised. The housing and consequently the rechargeable battery may thus be made lighter in weight. The plug simultaneously simplifies draining of the liquid fluid, hereafter also denoted liquid, from the housing when required, in particular in the event of maintenance. This in particular means that, where access to the rechargeable battery cells is desired or necessary, for example for replacement and the like, the fluid is drained from the housing, such that on the one hand maintenance of the rechargeable battery is simplified and/or losses of the fluid are reduced and/or contact between a person carrying out the maintenance and the fluid, in particular soiling of said person, is at least reduced. Maintenance of the rechargeable battery is thus overall made simpler.

According to the inventive concept, the rechargeable battery comprises the housing. The housing comprises a first housing part and a second housing part which bound an internal volume of the housing. Rechargeable battery cells of the rechargeable battery are accommodated in the internal volume. During operation, the internal volume is at least partially full of the liquid fluid for temperature control, in particular for cooling, of the rechargeable battery cells, such that at least one of the rechargeable battery cells, advantageously each rechargeable battery cell, is surrounded by the fluid. During operation, the fluid conveniently flows through the housing, such that fluid exchange takes place in the housing. The tension rod undoably fastens the housing parts to one another, wherein the tension rod comprises a bolt and a bolt head. The bolt is guided through the internal volume and comprises a structure which forms an undoable connection with a counter-structure on the first housing part. The second housing part comprises a feed-through orifice which is open to the internal volume and to the surrounding environment and through which the bolt is guided and in the region of which the bolt head rests against the second housing part in such a manner that the tension rod undoably fastens the housing parts to one another. The tension rod may thus when required release the fastening of the housing parts, such that the housing parts can, if need be, in particular in the event of maintenance, be undone from one another in order to provide access to the internal volume and consequently to the rechargeable battery cells. The plug is displaceable between an open position and a closed position. In the open position, the plug opens up a fluidic drain path from the internal volume to the surrounding environment of the housing, such that, in the open position of the plug, the fluid flows out of the internal volume into the surrounding environment. In the closed position, into which the plug is conveniently displaced during operation, the plug closes said fluidic drain path, such that flow of the fluid via the drain path is shut off.

The tension rod and plug are thus in each case displaceable. The tension rod fixes the housing parts in a fastened position, as described above. This fastening is, as mentioned, undoable, such that the tension rod is displaceable between the fastened position and an undone position, in which this fastening of the housing parts is undone.

The liquid fluid may in principle be any desired such fluid. The fluid is in particular a coolant for cooling the rechargeable battery cells. The fluid is advantageously dielectric, such that the fluid does not give rise to any electrical connections between the rechargeable battery cells and/or the surrounding environment and/or the housing.

In addition to the tension rod, the rechargeable battery advantageously comprises further connecting elements, such as for example screws and the like, which connect the housing parts to one another. These connecting elements are advantageously likewise undoable, such that the housing parts can, if need be, be completely undone from one another, in order to permit access to the internal volume and/or to the rechargeable battery cells.

It is advantageous for the tension rod to be arranged centrally in the housing in order to provide targeted and efficient fastening of the housing parts and thus improved compensation of the internal pressure in the housing brought about by the liquid.

The additional connections are, if present, advantageously mounted peripherally on the housing parts.

The plug and tension rod may in principle be arranged entirely spaced apart from one another.

The plug is conveniently mounted on the housing such a way that, on the displacement of the plug into the open position, the fluid present in the housing flows out of the housing under the effect of gravity. The plug is thus preferably arranged in a lower housing part in the mounted state in the associated application.

Preferred embodiments are those in which the plug is provided on the bolt head of the tension rod and the drain path extends through the feed-through orifice. The feed-through orifice thus simultaneously serves as a drain orifice for draining the fluid from the internal volume of the housing. The formation and production of the rechargeable battery is thus considerably simplified. Maintenance of the rechargeable battery is furthermore simplified in this way, since the accesses to the plug and tension rod are combined or coincide. The plug may here be arranged eccentrically relative to the bolt head. Embodiments in which the plug and bolt head are arranged concentrically are also conceivable.

The plug may in principle be of any desired construction. In particular, the plug may be a body which, for displacement into the closed position and thus shutting off the drain path, is pushed into an associated orifice, for example in the bolt head.

Preferred embodiments are those in which the plug is constructed as a drain screw which is displaced between the open position and the closed position with a screw connection and/or bayonet connection. Displacement of the plug between the open position and the closed position is thus simplified and/or achieved inexpensively. In addition, chance or unintended displacement of the plug is thus prevented or the associated risk at least reduced.

In preferred embodiments, the plug is constructed integrally with the screw head, such that, on establishing of the undoable connection between the bolt and first housing part, i.e. on displacement of the tension rod into the fastened position, the plug is displaced with the tension rod into the closed position, and such that, on undoing of the connection of the bolt to the first housing part, i.e. on displacement of the tension rod into the undone position, the plug is displaced with the tension rod into the open position. This considerably simplifies production of the rechargeable battery and considerably simplifies handling of the rechargeable battery, in particular during the maintenance of the rechargeable battery.

It is here particularly preferred for the bolt head to be the plug. In other words, it is preferred for the tension rod simultaneously to be constructed as a drain plug. This means that the tension rod for fastening the housing parts is simultaneously constructed as a tension rod and a drain plug. This directly results in the fastened position of the tension rod corresponding to the closed position of the drain plug and the undone position of the tension rod to the open position of the drain plug. The rechargeable battery is thus of simpler construction and/or can be produced more inexpensively. This additionally increases the stability of the housing with regard to the internal pressure because no separate and/or additional orifice is provided for the plug. Assembly of the rechargeable battery and handling of the rechargeable battery in the event of maintenance are furthermore distinctly simplified in this manner.

The tension rod may here be of multipart construction, in particular the bolt and bolt head may be components which are produced separately and fixed to one another.

The tension rod is preferably produced in one piece, in particular from a single material. The tension rod may for example be moulded, in particular injection-moulded. The tension rod may in particular be moulded, for example injection-moulded, from a plastics material.

It is in principle conceivable for the bolt of the tension rod to be uncovered in the internal volume of the housing.

Preferred embodiments are those in which the tension rod is guided by an intermediate plate arranged between two adjacent rechargeable battery cells. This results in increased stability of the housing and thus of the rechargeable battery and additionally simplifies assembly and maintenance of the rechargeable battery. The intermediate plate conveniently comprises a plate orifice which is associated with the bolt and through which the bolt is passed.

Advantageous embodiments are those in which a seal is provided between the plug and the second housing part, which seal, in the closed position of the plug, results in a fluidic seal between the plug and the housing. The seal is advantageously constructed as an annular seal.

If the plug is arranged in the bolt head or the tension rod is constructed as a drain plug, the seal is, in the closed position or fastened position, advantageously arranged in the feed-through orifice between the plug and the second housing part.

Assembly of the rechargeable battery is simplified and/or handling of the rechargeable battery in the event of maintenance is simplified and/or sealing is improved by the plug, in particular the bolt head, comprising an open groove in which the seal is accommodated. The groove is advantageously open to the outside.

The connection established with the bolt structure and counter-structure on the first housing part may in principle be of any kind, provided it is undoable and fastens the housing parts to one another. The bolt structure and the counter-structure on the first housing part advantageously form a screw connection or bayonet connection.

The counter-structure on the first housing part may in principle be formed and constructed in the first housing part.

Advantageous embodiments are those in which a sleeve is accommodated on the first housing part in an associated receptacle, wherein the sleeve comprises the counter-structure which, with the bolt structure, forms the undoable connection. A counter-structure formed in the first housing part is thus not necessary or present, such that the first housing part can be simplified and/or produced more inexpensively.

In the closed position or fixed position, the plug, in particular the bolt head, may project from the second housing part and rest externally against the second housing part.

Preferred embodiments are those in which, in the closed position or fastened position, the plug and/or the bolt head are recessed in the feed-through orifice. Preferred embodiments are those in which, in the closed position or the fastened position, the plug or the bolt head is entirely recessed in the feed-through orifice, such that it comprises no portion which projects on that side of the second housing part which is remote from the internal volume. In particular, in this position, the plug or the bolt head is flush with the second housing part on the side remote from the internal volume. In this way, a more structurally compact configuration of the rechargeable battery is achieved and/or damage to and unintended displacement of the plug or the tension rod is prevented or the associated risk is at least reduced.

The plug and/or the tension rod are/is preferably displaced with the assistance of an associated tool.

The plug preferably comprises to this end a corresponding structure, hereafter also denoted tool structure, which interacts with an associated tool for the purposes of displacing the plug. The tool structure is in particular a plug recess which interacts with the tool in interlocking manner. The recess is for example a recess in the form of a square, hexagon or the like.

The rechargeable battery according to the invention may be used for any desired application. In particular, the rechargeable battery is used in a motor vehicle in which the rechargeable battery for example serves for the drive of the motor vehicle.

The housing conveniently comprises an inlet, which is separate from the feed-through orifice and the drain path and which serves for admitting the fluid into the housing, and an outlet for discharging the fluid from the housing.

The inlet and the outlet of the housing are advantageously included in a circuit through which the fluid circulates during operation. This circuit may include a heat exchanger for temperature control of the fluid, in particular for cooling the fluid and thus for absorbing the heat absorbed by the fluid in the rechargeable battery.

Further important features and advantages of the invention are revealed by the subclaims, the drawings and the associated description of the Figures made with reference to the drawings.

It goes without saying that the above-mentioned features and those still to be explained below may be used not only in the respectively stated combination but also in other combinations or alone, without going beyond the scope of the present invention.

Preferred exemplary embodiments of the invention are illustrated in the drawings and are explained in more detail in the following description, wherein the same reference numerals refer to identical or similar or functionally identical components.

### BRIEF DESCRIPTION OF THE DRAWINGS

In the schematic figures

FIG. 1 shows a greatly simplified, circuit diagram-like representation of a motor vehicle with a rechargeable battery,

FIG. 2 shows a section through the rechargeable battery with a first housing part, a second housing part and a tension rod,

FIG. 3 shows an isometric view of the second housing part,

FIG. 4 shows an isometric view of the tension rod,

FIG. 5 shows a section through the rechargeable battery in the region of the tension rod in another exemplary embodiment,

FIG. 6 shows the section from FIG. 5 in a further exemplary embodiment.

### DETAILED DESCRIPTION

A rechargeable battery 1, as shown in greatly simplified form in FIGS. 1 to 6, is for example used in a motor vehicle 2 shown in circuit diagram-like form in FIG. 1. The rechargeable battery 1 here serves as an electrical power source which, via an electrical terminal 3 indicated in FIG. 1, supplies the motor vehicle 2 with electrical power, for example to drive it, and/or via which the rechargeable battery 1 is recharged.

The rechargeable battery 1 comprises a housing 4 with an internal volume 5. During operation, a liquid fluid 6 flows through the internal volume 5, passing into the internal volume 5 via an inlet 7 of the housing 4 and flowing out of the internal volume 5 via an outlet 8 of the housing 4. Rechargeable battery cells 9, for example pouch cells 10, which are temperature-controlled, in particular cooled, with the fluid 6, are accommodated in the internal volume 5. The internal volume 5 is here at least partially full of the fluid 6, such that at least one of the rechargeable battery cells 9 is surrounded by the fluid 6 during operation.

In the example shown in FIG. 1, the rechargeable battery 1 is included in a circuit 11 through which the fluid 6 circulates. In addition to the rechargeable battery 1, the circuit 11 also includes a heat exchanger 12 for temperature control of the fluid 6, in particular a cooler 13 for cooling the fluid 6, wherein the heat exchanger 12 may have a temperature-control medium 14 flowing through it in a fluidically separate manner from the fluid 6, such that heat exchange between the fluid 6 and the temperature-control medium 14 occurs during operation. The fluid 6 in particular cools the rechargeable battery cells 9. The liquid fluid 6 may accordingly be a coolant 15. The fluid 6 is preferably dielectric, such that it does not establish any electrical connections.

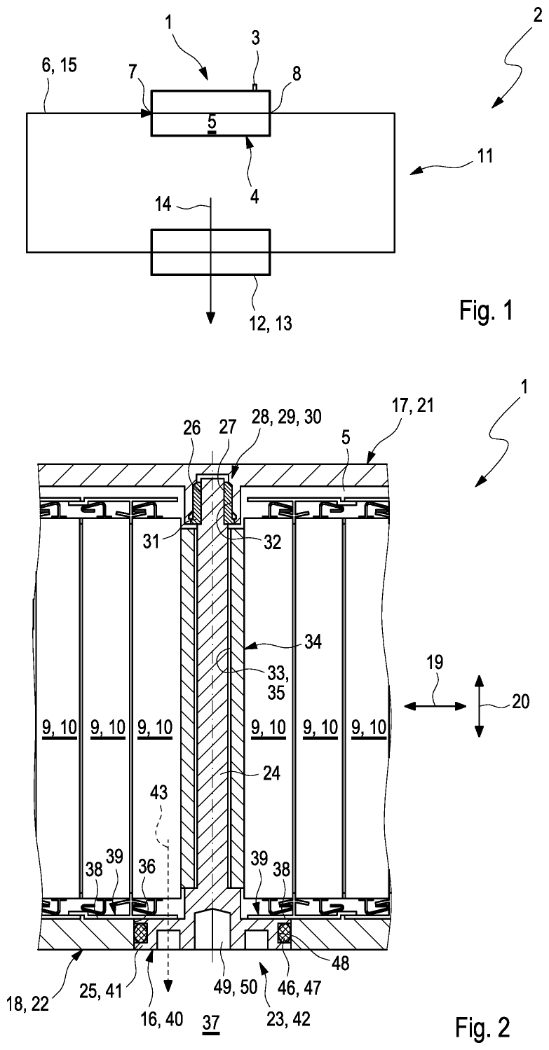

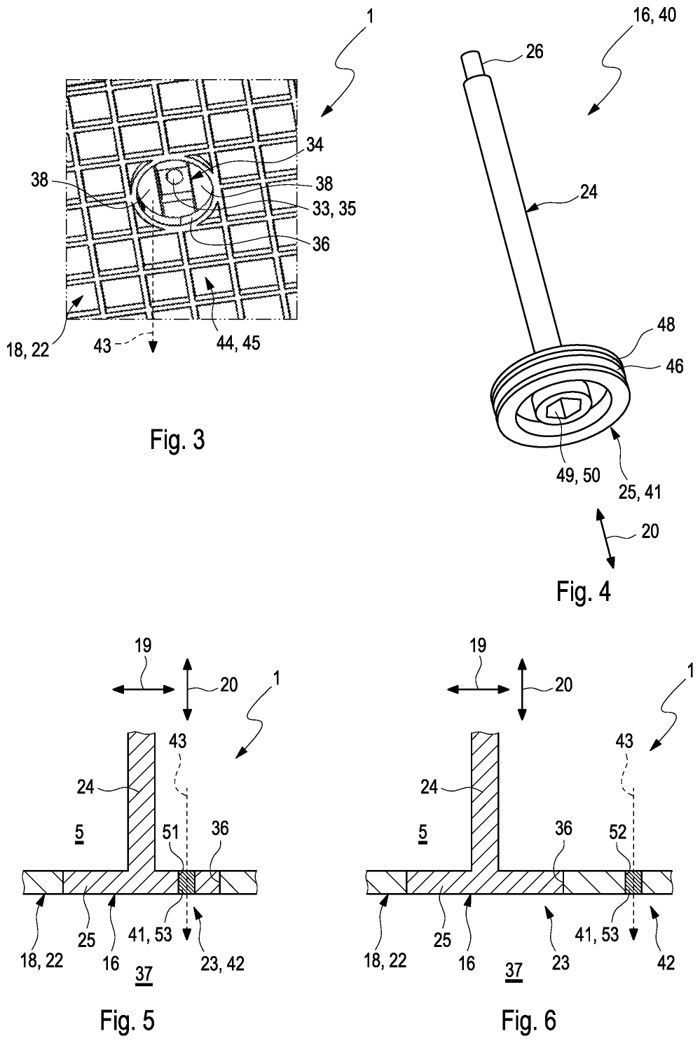

FIG. 2 shows a section through the rechargeable battery 1 in the region of a tension rod 16, wherein a first housing part 17 and a second housing part 18 can be seen. FIG. 3 shows an isometric external view of the second housing part 18 and FIG. 4 shows an isometric view of the tension rod 16.

The housing 4 accordingly comprises the first housing part 17 and the second housing part 18, which bound, in particular enclose, the internal volume 5 of the housing 4. The rechargeable battery cells 9 are arranged in succession in a stack direction 19 in the internal volume 5. The housing parts 17, 18 are arranged opposite one another in a height direction 20 which extends transversely in relation to the stack direction 19. One of the housing parts 17, 18, for example the first housing part 17, may be a trough-shaped housing sump 21, and the other housing part 17, 18, for example the second housing part 18, may be a housing cover 22, or cover 22 for short, which closes the housing sump 21. The rechargeable battery cells 9 are advantageously accommodated in the housing sump 21 and preferably fixed, in particular undoably, in the housing sump 21. The tension rod 16 fastens the housing parts 17, 18 undoably to one another, wherein FIG. 2 shows a fastened position 23 of the tension rod 16, in which the tension rod 16 fastens the housing parts 17, 18 to one another. The tension rod 16 here comprises a bolt 24 and a bolt head 25, wherein, in the fastened position, the bolt 24 projects out from the bolt head 25 in the height direction 20. In the fastened position 23 which is shown, the bolt 24 extends through the internal volume 5 and is guided through the internal volume 5. The bolt 24 comprises a structure 26 which, with a counter-structure 27 on the first housing part 17, thus in the present case on the housing sump 21, forms an undoable connection 28 for undoably fastening the housing parts 17, 18 to one another. In the example shown, the structure 26 is merely provided in an end portion, which faces or is adjacent to the first housing part 17, of the bolt 24. The structure 26 and counter-structure 27 may here for example form a screw connection 29 or a bayonet connection 30. In the example shown, the counter-structure 27 is additionally constructed in a sleeve 31 which is accommodated in an associated receptacle 32 arranged on that side of the first housing part 17 which faces the internal volume 5 and is thus on the inner side. As is in particular furthermore apparent from FIGS. 2 and 3, the bolt 24 is guided through a plate orifice 33 of an intermediate plate 34, wherein the plate orifice 33 serves as a guide 35 for the bolt 24 and extends in the height direction 20. The intermediate plate 34 is arranged between two rechargeable battery cells 9 which succeed one another in the stack direction 19, wherein these rechargeable battery cells 9 in each case lie, preferably flat, against the side of the intermediate plate 34 remote from the bolt 24.

The second housing part 18, in the present case thus the cover 22, comprises a feed-through orifice 36 which is arranged opposite the counter-structure 27, in the present case thus the sleeve 31 or the receptacle 32, in the height direction 20. The feed-through orifice 36 is open on the one hand to the internal volume 5 and on the other hand to the surrounding environment 37 of the housing 4. The bolt 24 is guided through the feed-through orifice 36. In other words, in order to fasten the housing parts 17, 18 to one another, the tension rod 16 is guided first through the feed-through orifice 36 and then through the plate orifice 34. In the fastened position 23, the bolt head 25 rests against the second housing part 18 in such a way that the tension rod 17 fastens the housing parts 17, 18 to one another and prestresses them against one another.

The tension rod 16 is displaced into the undone position 44 shown in FIG. 3 by undoing the connection 28 and at least in part removing, in particular withdrawing, the tension rod 16 in the height direction 20 from the housing 4. In the example shown, in the fastened position 23, the bolt head 25 is entirely recessed in the feed-through orifice 36, such that the bolt head 25 does not project from the side of the second housing part 22 remote from the internal volume 5 and is thus in particular flush with said side. In the example shown, the bolt head 25 here rests against two outer walls 38, spaced from one another in the stack direction 19, of in each case one retainer 39 for retaining rechargeable battery cells 9 in the housing 4.

Viewed together, FIGS. 2 to 4 furthermore reveal that the tension rod 16 simultaneously serves as a drain plug 40 with which the fluid 6 may, when required, be drained out of the internal volume 5. The bolt head 25 here simultaneously serves as a plug 41 which permits this draining. In a closed position 42, the plug 41 closes a drain path 43, shown in dashed lines in FIGS. 2 and 3, between the internal volume 5 and the surrounding environment 37 for draining the fluid out of the internal volume 5. The identity between the tension rod 14 and the outer plug 40 means that the closed position 42 corresponds to the fastened position 23. In the open position 45, visible in FIG. 3, of the plug 41, which position corresponds to the undone position 44 of the tension rod 16 due the identity between the tension rod 16 and the drain plug 40, the plug 41 opens up the drain path 43, such that the fluid 6 can flow out of the internal volume 5 into the surrounding environment 37. The drain path 43 thus extends from the internal volume 5 through the feed-through orifice 36 into the surrounding environment 37. The second housing part 18 is here advantageously that housing part 18 which, in the associated application, in particular in the motor vehicle 2, is located below the first housing part 17, such that the fluid 6 can flow out along the drain path 43 under the effect of gravity.

As is in particularly apparent from FIGS. 2 and 4, a seal 46, preferably an annular seal 47, may be arranged between the plug 41 and the second housing part 18, preferably in the feed-through orifice 36, for sealing the drain path 43 in the closed position 42, thus in the fastened position 23 in the example shown in FIGS. 2 to 4. The seal 46 is here accommodated in a groove 48, open to the outside, of the plug 41, thus of the bolt head 25 in the example shown.

As is furthermore apparent from FIGS. 2 and 4, the plug 41 and thus the bolt head 25 in the example shown comprise a tool structure 49, which may for example be constructed as a hexagonal receptacle 50. The tool structure 49 here interacts with an associated tool (not shown) for the purposes of displacing the plug 25 or the tension rod 16 between the closed position 42 and the open position 45 or between the undone position 44 and the fastened position 23.

FIG. 5 shows another exemplary embodiment of the rechargeable battery 1, wherein FIG. 5 merely shows the second housing part 18 with the tension rod 16 and the plug 41. In this exemplary embodiment, the plug 41 is separate from the bolt head 25 but integrated in the bolt head 25. For this purpose, an opening 51 is provided in the bolt head 25, which opening sealingly accommodates the plug 41 in the closed position 42. FIG. 5 here shows the fastened position 23 of the tension rod 16 and the closed position 42 of the plug 41. The plug 41 is displaced by removing (not shown) the plug 41 from the opening 51.

In the exemplary embodiment shown in FIG. 6, the plug 41 is separate from the tension rod 16 and spaced from the tension rod 16. A plug orifice 52, which is spaced apart from the feed-through orifice 36 and is open to the internal volume 5 and the surrounding environment 37, is here provided in the second housing part 18 for the plug 41, in which plug orifice the plug 41 is sealingly arranged in the closed position 42. The plug 41 is displaced into the open position 45 (not shown) by being removed from the plug orifice 52.

In the exemplary embodiments shown in FIGS. 5 and 6, the plug 41 is preferably constructed as a drain screw 53, which, for displacement between the open position 45 and closed position 42, interacts with a drain thread (not shown) in the bolt head 25 or in the plug orifice 52.

In all the examples shown, the tension rod 16 is advantageously produced in one piece, for example entirely by a moulding method, in particular an injection moulding method.

1. A rechargeable battery, comprising:
a housing including a first housing part and a second housing part;
a plurality of rechargeable battery cells accommodated in an internal volume of the housing defined between the first housing part and the second housing part;
the internal volume at least partially full, during operation, of a liquid fluid for temperature control of the plurality of rechargeable battery cells such that at least one of the plurality of rechargeable battery cells is surrounded by the fluid;
a tension rod undoably coupling the first housing part and the second housing part to one another;
the tension rod including a bolt and a bolt head;
the bolt guided through the internal volume and including a structure configured to form an undoable connection with a counter-structure arranged on the first housing part;
the second housing part including a feed-through orifice open to the internal volume and to a surrounding environment of the housing;
the bolt guided through the feed-through orifice;
the bolt head resting against the second housing part such that the tension rod undoably couples the first housing part and the second housing part to one another;
a plug which, when in an open position, opens up a fluidic drain path from the internal volume to the surrounding environment of the housing such that the fluid flows out of the internal volume into the surrounding environment; and
wherein, when the plug is in a closed position, the plug shuts off the drain path.

2. The rechargeable battery according to claim 1, wherein:
the plug is disposed on the bolt head of the tension rod; and
the drain path extends through the feed-through orifice.

3. The rechargeable battery according to claim 2, wherein the plug is structured as a drain screw configured to interact with a drain thread disposed in the bolt head.

4. The rechargeable battery according to claim 2, wherein the plug is structured integrally with the bolt head such that (i) when the undoable connection between the bolt and the first housing part is established, the plug is disposed in the closed position and, (ii) when the undoable connection is undone, the plug is disposed in the open position.

5. The rechargeable battery according to claim 4, wherein the bolt head defines the plug such that the tension rod is structured as a drain plug.

6. The rechargeable battery according to claim 1, wherein the tension rod has a one-piece construction.

7. The rechargeable battery according to claim 1, wherein the tension rod is arranged centrally in the housing and extends transversely relative to a height direction extending between the first housing part and the second housing parts.

8. The rechargeable battery according to claim 1, wherein:
an intermediate plate is arranged between two rechargeable battery cells of the plurality of rechargeable battery cells, the two rechargeable battery cells arranged transversely adjacent to the bolt; and
the intermediate plate includes a plate orifice through which the bolt is guided.

9. The rechargeable battery according to claim 1, wherein, when the plug is in the closed position, a seal is arranged between the plug and the second housing part.

10. The rechargeable battery according to claim 9, wherein the plug includes a groove opening to an outside and in which the seal is accommodated.

11. The rechargeable battery according to claim 1, wherein the structure of the bolt and the counter-structure on the first housing part are configured to establish one of a screw connection and a bayonet connection when engaged.

12. The rechargeable battery according to claim 1, wherein the counter-structure is structured as a sleeve accommodated in the first housing part.

13. The rechargeable battery according to claim 2, wherein, when the plug is in the closed position, the plug is recessed in the feed-through orifice.

14. The rechargeable battery according to claim 1, wherein the plug includes, on a side remote from the internal volume when in the closed position, a tool structure configured to interact with a tool for displacing the plug between the closed position and the open position.

15. A rechargeable battery, comprising:
a housing including a first housing part, a second housing part, and an internal volume defined between the first housing part and the second housing part;
a plurality of rechargeable battery cells arranged within the internal volume of the housing such that at least one of the plurality of rechargeable battery cells is surrounded by a liquid fluid that at least partially fills the internal volume during operation for temperature control of the plurality of rechargeable battery cells;
a tension rod releasably coupling the first housing part and the second housing part to one another, the tension rod including a bolt and a bolt head, the bolt including a connecting structure configured to form a releasable connection with a complimentary counter-structure of the first housing part;
an adjustable plug structured and arranged such that (i) a fluidic drain path extending from the internal volume to a surrounding environment of the housing through which the fluid is flowable is open when the plug is in an open position and (ii) the plug closes the drain path when in a closed position;
wherein the second housing part includes a feed-through orifice open to the internal volume and to the surrounding environment of the housing;
wherein the bolt is guided through the feed-through orifice and the internal volume; and
wherein the bolt head rests against the second housing part.

16. The rechargeable battery according to claim 15, wherein the drain path extends through the feed-through orifice.

17. The rechargeable battery according to claim 16, wherein the plug is structured integrally with the bolt head such that (i) when the releasable connection between the bolt and the first housing part is established, the plug is disposed in the closed position and (ii) when the releasable connection is released, the plug is disposed in the open position.

18. The rechargeable battery according to claim 15, further comprising an intermediate plate arranged between two adjacent rechargeable battery cells of the plurality of rechargeable battery cells, and wherein the bolt extends through a plate orifice disposed in the intermediate plate.

19. The rechargeable battery according to claim 15, wherein:
the plug includes a tool structure configured to interact with a tool; and
the tool structure is structured and arranged to facilitate adjustment of the plug between the closed position and the open position via the tool.

20. A rechargeable battery, comprising:
a housing including a first housing part, a second housing part, and an internal volume defined between the first housing part and the second housing part;
a plurality of rechargeable battery cells arranged within the internal volume of the housing such that at least one of the plurality of rechargeable battery cells is surrounded by a liquid fluid that at least partially fills the internal volume during operation for temperature control of the plurality of rechargeable battery cells;
a tension rod releasably coupling the first housing part and the second housing part to one another, the tension rod including a bolt and a bolt head, the bolt including a connecting structure configured to form a releasable connection with a complimentary counter-structure arranged on the first housing part;
an adjustable plug structured and arranged such that (i) a fluidic drain path extending from the internal volume to a surrounding environment of the housing through which the fluid is flowable is open when the plug is in an open position and (ii) the plug closes the drain path when in a closed position;
wherein the second housing part includes a feed-through orifice open to the internal volume and to the surrounding environment of the housing;
wherein the bolt is guided through the feed-through orifice and the internal volume;
wherein the bolt head rests against the second housing part; and
wherein the plug includes an annular grooving opening to an outside and an annular seal is arranged within the groove.
